(19) United States
(12) Patent Application Publication
(10) Pub. No.: US 2015/0294381 A1
(43) Pub. Date: Oct. 15, 2015

(54) SYSTEM AND METHOD FOR CONNECTING TRADING PARTNERS IN A COMMERCE NETWORK

(71) Applicant: Elemica, Inc., Wayne, PA (US)

(72) Inventors: Arun SAMUGA, Atlanta, GA (US); Richard KATZ, Atlanta, GA (US); Blake SCHNORF, Atlanta, GA (US)

(21) Appl. No.: 14/749,201

(22) Filed: Jun. 24, 2015

Related U.S. Application Data
(63) Continuation of application No. 14/534,941, filed on Nov. 6, 2014.
(60) Provisional application No. 61/901,553, filed on Nov. 8, 2013.

(51) Int. Cl. G06Q 30/06

(52) U.S. Cl. CPC G06Q 30/0605

(57) ABSTRACT

A method for recommending a first member of a trading network to a second member of a trading member of the network, wherein the network includes a message translation system, a pattern recognition engine and a discovery portal. The method for recommending includes identifying a first plurality of trading parameters of the first member with the message translation system and identifying a second plurality of trading parameters of the second member with the message translation system. The method also includes identifying patterns that are related between the first plurality of trading parameters and the second plurality of trading parameters with the pattern recognition engine and sending a recommendation message to the second member regarding the first member based on the identified patterns that relate the first member to the second member.

### CROSS-REFERENCE TO RELATED APPLICATION

This application is a continuation of U.S. patent application Ser. No. 14/534,941, filed Nov. 6, 2014 and claims the benefit under 35 U.S.C. §119(e) of U.S. Provisional Patent Application No. 61/901,553, filed Nov. 8, 2013.

### BACKGROUND OF THE INVENTION

Commerce networks provide a means for electronically connecting buyers, sellers, logistics service providers, carriers, customers, suppliers, warehouses, customs agents, freight forwarders and other similar actors in a trading network, which may be generally characterized as trading partners. Trading partners can enhance their trading network by being electronically connected to many different trading partners in the trading network. As a result, a trading partner may be able to obtain better efficiency and savings, and the corresponding trading partner may be able to realize additional sales and efficiencies.

It would be desirable for trading partners to connect to more of their trading partners in the trading network to gain a larger network. Simplifying connections between a first trading partner who provides services that are often used or required by a second trading partner is desirable, as making such connection is often difficult and labor intensive.

There is a need for a system, method and/or apparatus for a commerce network that recommends trading partners to do business on the commerce network based on master data stored in the commerce network, tags stored in the master data, business processes, product characteristics and/or locations of operations.

### BRIEF SUMMARY OF THE INVENTION

Briefly, the preferred embodiments of the system and method relate generally to a trading partner commerce network. More particularly, the preferred embodiments relate to a method, an apparatus and a system for a commerce network for recommending and connecting trading partners who are on the commerce network, but are generally not transacting with each other.

An embodiment of the preferred system includes a computer-method of a commerce network for recommending trading partners to connect on the commerce network based on patterns that occur on or in the commerce or trading network. The computer-method includes identifying a trading partner's master data stored in the commerce network (e.g., products, locations addresses, etc.), tags stored in the master data (such as certifications, hub partners, small business status, etc.) or behavior on the commerce network including their products transacted on the network, the processes they conduct on the network (e.g., vendor managed inventory, invoicing, etc.) and the locations in which they transact business in the world or where the trading partner ships goods throughout the world. The computer-method further includes identifying another trading partner for the first trading partner to connect with based on information that is similar to, or related to, the first trading partner. In the preferred embodiment, the computer-method also includes identifying complementary relationships in the trading network based on similarities and/or needs of the various trading partners in the network. For example, the supply chain communications system may identify and recommend a buyer to a supplier or a carrier to a shipper based on analysis of various messages that the buyer, supplier, carrier and shipper transmit through the supply chain communications system that indicate a complementary relationship may exist between the buyer and supplier or the carrier and the shipper. The identification of the complementary relationship and the recommendation also preferably depends on the supply chain communications system recognizing that there is no or limited contact between the buyer and supplier or the carrier and the shipper before any recommendation is presented to the buyer, supplier, carrier or shipper. The computer-method further includes recommending the first trading partner to the other trading partner(s) by identifying patterns in the first trading partner that relate to patterns identified in the other trading partner(s).

Another preferred embodiment relates to a commerce network for recommending trading partners to connect on the commerce or trading network based on patterns that occur on the commerce network. The commerce network includes at least one commerce network server connected through a network to trading partner servers. At least one commerce network server is operative to identify trading partner master data, tags or behavior on the commerce network, including their products transacted on the network, the processes they conduct on the network (e.g., vendor managed inventory, invoicing, etc.) and the locations in which they transact business in the world. At least one commerce network server is operative to identify other trading partner information that is similar to, or related to, the first trading partner. At least one commerce network server is further operative to recommend a trading partner to other trading partners by identifying patterns in the first trading partner with information related to the other trading partner.

Another embodiment includes a program storage device readable by a machine, tangibly embodying a program of instructions executable by the machine to perform a computer-method of a commerce network for trading partners to connect on the commerce network based on patterns that occur on the commerce or trading network. The computer-method includes identifying a trading partner's master data, tags or behavior on the commerce network, including their product transacted on the network, the processes they conduct on the network (e.g., vendor managed inventory, invoicing, etc.) and the locations in which they transact business in the world. The computer-method further includes identifying other trading partner(s) information that is similar to, or related to, the first trading partner. The computer-method further includes recommending the other trading partner(s) that the subject trading partner is not currently doing business with, to the trading partner by identifying patterns in the first trading partner and comparing the identified patterns with patterns of the other trading partner.

Other aspects and advantages of the described embodiment will become apparent from the following detailed description, taken in conjunction with the accompanying drawings, illustrating by way of example the principles of the described preferred embodiment.

### BRIEF DESCRIPTION OF THE SEVERAL VIEWS OF THE DRAWINGS

The foregoing summary, as well as the following detailed description of the preferred invention, will be better understood when read in conjunction with the appended drawings. For the purpose of illustrating the preferred invention, there is shown in the drawings an embodiment which is presently preferred. It should be understood, however, that the invention is not limited to the precise arrangements and instrumentalities shown. In the drawings:

FIG. 1 is a block diagram of a system that facilitates recommending trading partners, according to a preferred embodiment of the present invention;

FIG. 2 is an exemplary sequence diagram tracking the process used in the preferred embodiment of the system of FIG. 1; and

FIG. 3 is a flow chart that includes steps of a computer-method of a commerce network for recommending trading partners, according to the preferred embodiment of the system of FIG. 1.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one.” The words “right,” “left,” “lower,” and “upper” designate directions in the drawings to which reference is made. The words “inwardly” or “distally” and “outwardly” or “proximally” refer to directions toward and away from, respectively, the geometric center or orientation of the system, device, instruments, components and related parts thereof. The terminology includes the above-listed words, derivatives thereof and words of similar import.

The preferred embodiment of a supply chain operating system network 110 includes methods, systems and apparatuses for electronically recommending trading partners, generally identified by reference numeral 118 (which includes, but is not limited to, a first buyer/seller 117a, a second buyer/seller 117b, and a logistics service provider 119). The trading partners 118 may be nearly any person or entity that trades goods or services in a trading network and are preferably comprised of suppliers, buyers, customers, carriers, warehouses, customs agents, freight forwarders, transportation providers and logistics service providers (e.g., road carriers, rail carriers, warehouses, customs agents) who operate in a trading network. The network 110 of the preferred embodiment recommends trading partners 118 to each other, such as recommending suppliers to buyers, buyers to suppliers, suppliers to carriers and/or buyers to carriers, but is not so limited. The preferred embodiment expands the number of trading partners 118 available for transacting business with a particular trading partner 118 and, therefore, allows the trading partner 118 to obtain efficiencies in the network 110 and to automate transactions by creating convenient connections with a desirable trading partner 118 that the identified trading partner 118 was not doing business with until the system 110 identified the desirable trading partner 118, as will be described in greater detail below.

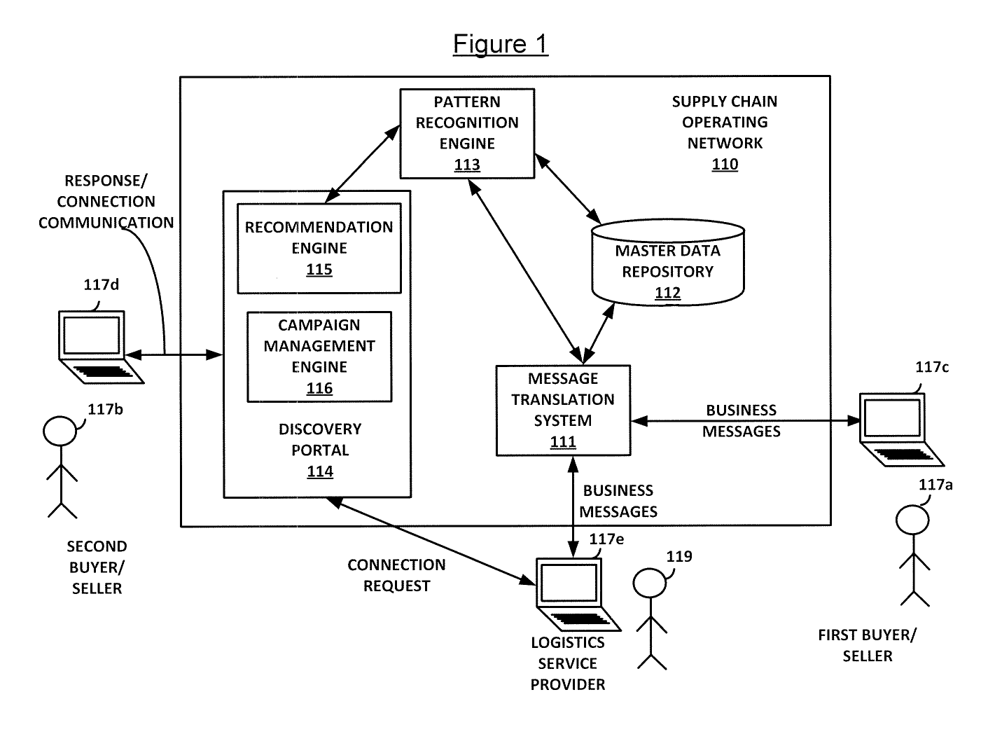

Referring to FIG. 1, the preferred supply chain network 110 facilitates recommending trading partners 118, such as a first buyer/seller 117a and a second buyer/seller 117b, to connect with each other or introducing the second buyer/seller 117b to the first buyer/seller 117a directly through the network 110, via, for example, computing terminals 117c and 117d respectively. The introduction of the first and second buyer/seller 117a, 117b through the network 110 is provided as a non-exclusive example of a connection that could be made through the network 110 and is not meant to be limiting. The network 110 may be utilized to connect nearly any trading partner 118 to another trading partner 118 if and when relevant connections are identified by the network 110. The connections between trading partners 118 in the network 110 are preferably based on similarities in their master data, tags, types of transactions, locations for transactions or like information that is similar between the trading partners 118. In the preferred embodiments, the connections are made based on complementary relationships between the trading partners 118 in the network 110 that are identified or identifiable based on the messages that the trading partners 118 send through the network 110 by reviewing information in the messages, such as master data, tags, transaction type, transaction location, type of transportation used, transportation timing, pricing, product type, shipping volumes and other like information.

The preferred supply chain operating network 110 includes a commerce message translation system 111 that manages transactions between trading partners 118. In a preferred example, the commerce message translation system 111 is in communication with the first trading partner (e.g., first buyer/seller 117a), the second trading partner (e.g., second buyer/seller 117b) and a third trading partner (e.g., logistics service provider 119 via, for example, computing terminal 117e). The operating network 110 may further include a discovery portal 114 that includes a recommendation engine 115 and a campaign management engine 116. The operating network 110 may also include a pattern recognition engine 113 that monitors the message translation system 111 and a master data repository 112 for collecting data and recognizing or detecting patterns including products, packages, transport types (road, rail), from and to, restrictions, full truck load, less than truckload, unit of measures and related patterns and information that may be utilized to identify potential partners or business associates for introduction between the trading partners 118.

The recommendation engine 115 preferably recommends that the second trading partner 117b connects to or with the first trading partner 117a by recognizing similar trading patterns between the first and second trading partners 117a, 117b. The patterns are preferably recognized by the pattern recognition engine 113, however, the recommendation engine 115 may be configured to recommend trading partners 118 to each other or alternative recommendations may be between the network members 118. The recommendation engine 115 is preferably separate from the commerce network server 110 in the preferred embodiment. For at least some alternate preferred embodiments, the recommendation engine 115 and the commerce network 110 are included on a single server. For other alternative preferred embodiments, the recommendation engine 115 and the commerce network 110 are included over multiple servers.

The commerce network 110 may comprise an enterprise network that includes enterprise servers. The enterprise servers of the trading partners 118 are preferably connected (through, for example, the internet) to the commerce network 110. The commerce network 110 may include one or more servers that support the preferred embodiment for electronically recommending trading partners 118. In light of the embodiments of the present invention disclosed hereinthroughout, one of ordinary skill in the art would appreciate that the commerce networks server 110, the enterprise servers of the trading partners 118, and various components thereof, may be implemented or performed with one or more processors, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The one or more processors described hereinthroughout may be a microprocessor, but in the alternative, the processor may be any conventional processor, controller, microcontroller, or state machine. The one or more processors may also be implemented as a combination of computing devices, e.g., a combination of a DSP and a microprocessor, a plurality of microprocessors, one or more microprocessors in conjunction with a DSP core, or any other such configuration.

The master data repository 112 may be realized as random access memory (RAM), flash memory, erasable programmable read only memory (EPROM), electronically erasable programmable read only memory (EEPROM), registers, a hard disk, a removable disk, or any other form of storage medium known in the art.

In the preferred embodiment, a recommendation is driven by the business that the trading partners 118 operate in or the type of transactions that the trading partners 118 commence or participate in. That is, for example, based on the first trading partner's 117a master data in the master data repository 112 and its products, locations transacted, and related information. The preferred pattern recognition engine 113 recognizes similar patterns in the commerce network 110 as the trading partners 118 transact business through the network 110 and the pattern recognition engine 113 sends the recommendation to the recommendation engine 115 for presentation to the identified trading partner 118. If the identified trading partner 118 accepts the recommendation, the campaign management engine 116 preferably sends an electronic communication to both of the trading partners 118 by, faxing, emailing, phoning, tweeting, communicating with a small message system (sms), an RDF site summary (RSS) feeds, an application programming interface (API) based integration, third party integrations or otherwise communicating the accepted recommendation. Advantageously, the trading partners 118 then preferably respond to the campaign management engine 116 and get connected through the network 110.

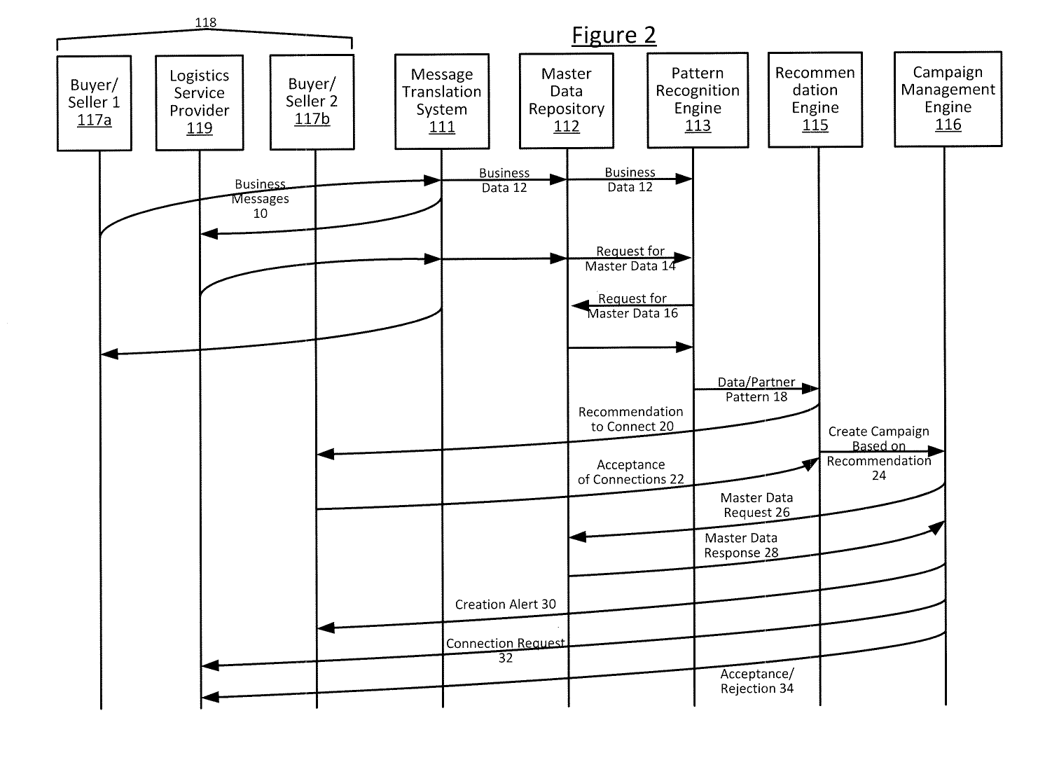

Referring to FIGS. 1 and 2, in operation, the first trading partner or first buyer/seller 117a, the second trading partner or second buyer/seller 117b and the logistics service provider 119 transact business through the supply chain operating network 110. The trading partners 118 of the network 110, including the first buyer/seller 117a, the second buyer/seller 117b and the logistics service provider 119, preferably transmit business messages 10, such as purchase orders, change orders, invoices, ship requests or other related business messages, through the network 110 for business purposes. In the first preferred exemplary embodiment, the first buyer/seller 117a sends the business messages 10 to the message translation system 111. The business messages 10 are preferably transmitted through the message translation system 111 as they are routed through the network 110. The network 110 logs, filters and sends the business messages 10 and the message translation system 111 preferably sends business data 12 to the master data repository 112 and the pattern recognition system 113 for each of the trading partners 118 in the network 110 and for each business message 10. In preferred embodiments, the master data repository 112 is used as a lookup by extracting business data 12 from the message translation system 111 and using the extracted business data 12 to look-up/validate the data 12 against master data in the master data repository 112. The pattern recognition engine 113 preferably constantly or at some predetermined frequency requests master data 14 from the master data repository 112 and the master data repository 112 sends master data responses 16 to the pattern recognition engine 113. The pattern recognition engine 113 sends data/partner pattern information 18 to the recommendation engine 115 based on the plurality of business messages 10 sent by the trading partners 118, including the buyer/seller 117a, the second buyer/seller 117b and the logistics service provider 119. The recommendation engine 115 identifies patterns that are related among the plurality of trading partner pattern information 18 and sends a recommendation to connect 20 to the second buyer/seller 117b based on a recognized pattern having a commonality with business transactions of the first buyer/seller 117a.

The recommendation to connect 20 is typically a recommendation to connect to the second trading partner 117b based on a pattern recognized by the recommendation engine 115 indicating that the first and second trading partners 117a, 117b have similarities in their transactions, business messages 10 or other trading parameters that indicate they should or it may be advantageous for them to transact business. The recommendation to connect 20 is not limited to being sent to the second buyer/seller 117b for recommending transaction of business with the first trading partner 117a and may be a recommendation to contact or communicate with nearly any member of the network 110 or a non-member of the network 110 based on patterns recognized by the recommendation engine 115. The second buyer/seller 117b preferably responds to the recommendation engine 115 with an acceptance of connections 22 that accepts the recommendation to connect 20 to the first buyer/seller 117a or rejects the recommendation to connect 20. The second buyer/seller 117b may also fail to respond to the recommendation to connect 20, in which case the recommendation engine 115 may send a subsequent recommendation to connect 20, may determine that the failure to respond indicates a rejection of the recommendation to connect 20 or may otherwise react in a predetermined manner to the failure of the second buyer/seller 117b to respond to the recommendation to connect 20.

The recommendation engine 114 sends a create campaign based on a recommendation 24 to the campaign management engine 116 upon receipt of the acceptance of connections 22 from the second buyer/seller 117b. The campaign management engine 116 sends a request for master data 26 to the master data repository 112 based on the acceptance of connections 22 from the second buyer/seller 117b in order to create a program creation alert 30 and receives a master data response 28 from the master data repository 112. The campaign management engine 116 then creates the program creation alert 30 based on the master data response 28 and the create program based on the recommendation 24 and sends the program creation alert to the second buyer/seller 117b. The campaign management engine 116 also sends a connection request 32 to the logistics service provider 119. The logistics service provider 119 preferably returns an acceptance/rejection 34 to the campaign management engine 116 in response to the connection request 32 to accept or reject the connection request. The logistics service provider 119 may also elect to not respond to the connection request 32, in which case the campaign management engine 116 may send a replacement connection request 32, may assume the failure to respond to the connection request 32 is a rejection of the request or may otherwise act when the logistics service provider 119 fails to respond, based on pre-programmed rules in the campaign management engine 116.

The above is a preferred, non-limiting exemplary preferred embodiment of information flow in the network 110 related to the first and second buyer/seller 117a, 117b and the logistics service provider 119 and numerous additional and alternative steps and message routing series of events are contemplated by the preferred invention within the spirit and scope of the present disclosure. For example, the first and second buyer/sellers 117a, 117b and the logistics service provider 119 may be comprised of nearly any other combination of trading partners 118 in the network. The communications and recommendations of the recommendation engine 115 and the campaign management engine 116 are not meant to be limiting and the recommendation engine 115 and the campaign management engine 116 may be connected to nearly any trading partner 118 of the network 110 and even non-members that provide information to the network 110.

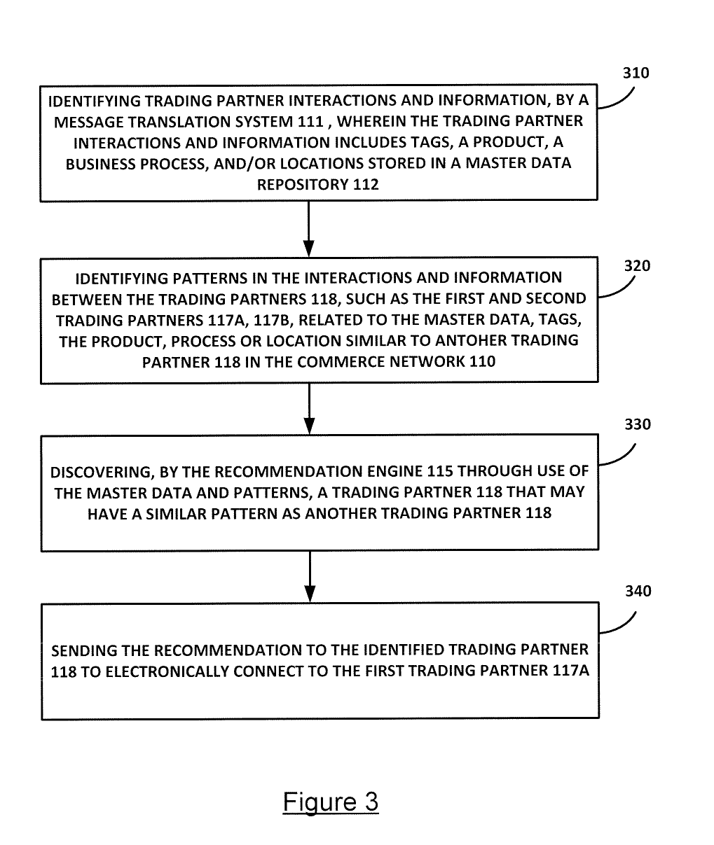

Referring to FIG. 3, preferred steps of a computer-method of the commerce network 110 for recommending one trading partner 118 to another trading partner 118 are shown. A first preferred step 310 includes identifying trading partner interactions and information through the message translation server or system 111. A second preferred step 320 includes identifying patterns in the interactions and information between the trading partners 118 related to the product, process, locations or other parameter that is similar to another trading partner 118 in the commerce network 110. A third preferred step 330 includes discovering, by the recommendation engine 115, through the use of master data and patterns, a trading partner 118 that may have similar patterns to another trading partner 118 in the network 110. Another preferred step 340 includes sending the recommendation to the identified trading partner 118 through the network 110.

It will be appreciated by those skilled in the art that changes could be made to the preferred embodiment described above without departing from the broad inventive concept thereof. It is understood, therefore, that this invention is not limited to the particular embodiment disclosed, but it is intended to cover modifications within the spirit and scope of the present invention as defined by the present disclosure.

We claim:

1. A method of establishing communications between supply chain communication partners for supply chain communications, the method comprising:
receiving, over a network interface of a supply chain communications system resident on at least one server, a first plurality of messages from a first trading partner, each message of the first plurality of messages destined for at least one recipient of a first plurality of recipients;
determining, by a message translation system, for each message of the first plurality of messages from the first trading partner, a message type of the message;
determining, by the message translation system, for each message of the first plurality of messages from the first trading partner, a required output format for the message, the required output format being determined based upon the determined message type of the message and configuration information related to the recipient of the message, the recipient being a recipient of the first plurality of recipients;
translating, by the message translation system, each message of the first plurality of messages from the first trading partner into the determined required output format for the message;
transmitting, using a network interface of the supply chain communications system, each translated message of the translated first plurality of messages to the recipient of the message;
storing, in a master data store on the at least one server, information regarding the first plurality of messages from the first trading partner;
storing, in the master data store resident on the at least one server, information regarding a second plurality of messages to a second trading partner, wherein the second trading partner is not among the first plurality of recipients; and
responsive to a determination of a correlation between at least a portion of the stored information regarding the first plurality of messages and at least a portion of the stored information regarding the second plurality of messages, transmitting, by a recommendation engine, information to the second trading partner regarding establishment of communications with the first trading partner.

2. The method of claim 1 further comprising:
responsive to receiving information from the second trading partner indicating that establishment of communications with the first trading partner is desired:
determining a first set of message types required for communication between the first trading partner and the second trading partner;
determining a second set of message types for which the messaging system is already configured for communication with the second trading partner; and
configuring the communications system to enable communications with the second trading partner using those message types of the first set of message types that are not included in the second set of message types.

3. The method of claim 2, wherein configuring the communications system to enable communications with the second trading partner using those message types of the first set of message types that are not included in the second set of message types comprises:
for each message type of those message types of the first set of message types that are not included in the second set of message types, presenting a user interface to facilitate mapping of data fields associated with the message type with fields associated with a message format required for communication of messages of the message type with the second trading partner.

4. The method of claim 2, wherein information from the second trading partner indicating that establishment of communications with the first trading partner is desired comprises an indication that a hyperlink was selected.

5. The method of claim 2, wherein the first set of message types required for communication between the first trading partner and the second trading partner is determined, at least in part, by using the stored information regarding the first plurality of messages from the first trading partner in the master data store.

6. The method of claim 1, wherein information regarding the first trading partner transmitted to the second trading partner comprises a recommendation to engage in supply chain communications with the first trading partner.

7. The method of claim 1, wherein information regarding the first trading partner transmitted to the second trading partner comprises a link to accept an invitation to engage in supply chain communications with the first trading partner.

8. The method of claim 1, wherein information regarding the first plurality of messages from the first trading partner in the master data store comprises message types.

9. The method of claim 1, wherein information regarding the first plurality of messages from the first trading partner in the master data store comprises business concepts associated with the message types of the messages of the first plurality of messages.

10. The method of claim 1, wherein determining a correlation between at least the information regarding the first plurality of messages and at least the information regarding the second plurality of messages comprises determining that a common message type exists within the first plurality of messages and the second plurality of messages.

11. The method of claim 10, wherein the common message type is a purchase order.

12. The method of claim 11, wherein the common message type is a purchase order for comprising a first product.

13. The method of claim 1, wherein determining a correlation between the first plurality of messages and the second plurality of messages comprises identifying at least one message of the second plurality of messages sharing at least two characteristics with at least one message of the first plurality of messages.

14. The method of claim 1 further comprising: conveying a third plurality of messages between the first pair of trading partners wherein the third plurality of messages comprises messages regarding the performance of a supply chain operation in which the identified logistics provider participates in the conveyance of goods from the first partner to the second partner.

15. The method of claim 1 further comprising:
receiving, over a network interface, a second plurality of messages from a first plurality of senders, each message of the second plurality of messages destined for the second trading partner;
determining, for each message of the second plurality of messages from the first plurality of senders, a message type of the message;
determining, for each message of the second plurality of messages from the first plurality of senders, a required output format for the message, the required output format being determined based upon the determined message type of the message and configuration information related to the recipient of the message, the recipient being the second trading partner;
translating each message of the second plurality of messages from the first plurality of senders into the determined required output format for the message; and
transmitting each translated message of the translated second plurality of messages to the second trading partner.

16. A supply chain communications system for establishing communications between supply chain communication partners, the system comprising:
a network interface configured to receive a first plurality of messages from a first trading partner, wherein each message of the first plurality of messages is destined for at least one recipient of a first plurality of recipients;
a message translation system configured to:
determine, for each message of the first plurality of messages from the first trading partner, a message type of the message;
determine, for each message of the first plurality of messages from the first trading partner, a required output format for the message, the required output format being determined based upon the determined message type of the message and configuration information related to the recipient of the message, the recipient being a recipient of the first plurality of recipients;
translate each message of the first plurality of messages from the first trading partner into the determined required output format for the message;
transmit using a network interface of the supply chain communications system, each translated message of the translated first plurality of messages to the recipient of the message;
a data repository configured to:
store information regarding the first plurality of messages from the first trading partner;
store information regarding a second plurality of messages to a second trading partner, wherein the second trading partner is not among the first plurality of recipients; and
a recommendation engine configured to transmit, in response to a determination of a correlation between at least a portion of the stored information regarding the first plurality of messages and at least a portion of the stored information regarding the second plurality of messages, information to the second trading partner regarding establishment of communications with the first trading partner.

17. The system of claim 16, wherein the message translation system is further configured to:
determine, in response to reception of information from the second trading partner indicating that establishment of communications with the first trading partner is desired, a first set of message types required for communication between the first trading partner and the second trading partner;
determine, in response to reception of the information from the second trading partner indicating that establishment of communications with the first trading partner is desired, a second set of message types for which the messaging system is already configured for communication with the second trading partner; and
configure the supply chain communications system to enable communications with the second trading partner using those message types of the first set of message types that are not included in the second set of message types.

18. The system of claim 17, wherein the message translation system is further configured to:
for each message type of those message types of the first set of message types that are not included in the second set of message types, present a user interface to facilitate mapping of data fields associated with the message type with fields associated with a message format required for communication of messages of the message type with the second trading partner.

19. The system of claim 17, wherein information from the second trading partner indicating that establishment of communications with the first trading partner are desired comprises an indication that a hyperlink was selected.

20. The system of claim 17, wherein the first set of message types required for communication between the first trading partner and the second trading partner is determined at least in part using the stored information regarding the first plurality of messages from the first trading partner in the master data store.
